(19) United States
(12) Patent Application Publication
(10) Pub. No.: US 2012/0199720 A1
(43) Pub. Date: Aug. 9, 2012

(54) ANTENNA MOUNTING BRACKET

(76) Inventor: John David Miller, Winston-Salem, NC (US)

(21) Appl. No.: 13/370,250

(22) Filed: Feb. 9, 2012

Related U.S. Application Data
(60) Provisional application No. 61/440,942, filed on Feb. 9, 2011.

(51) Int. Cl. H01Q 1/22; B23P 11/00; H01Q 1/12

(52) U.S. Cl. 248/535; 29/428

(57) ABSTRACT

An antenna mount attaches an antenna to a commercial vehicle. Often, such vehicles do not include antenna mounts for items such as a CB or satellite radio. The antenna mount may permit such antennas to be installed, interconnecting with an existing spot mirror attachment point. The antenna mount includes a bracket adapted to connect to a vehicle, typically between a spot mirror and a vehicle door, using the existing spot mirror mounting bolts. One or more rods may extend from the bracket. Antennas may then be attached to the rods. The antenna mount may allow for mounting capability for CB and/or satellite radio antennas. The chosen location of the antenna mount, behind the spot mirror, may also maximize satellite and CB radio signals.

### CROSS-REFERENCE TO RELATED APPLICATIONS

This application claims the benefit of priority of U.S. provisional patent application No. 61/440,942, filed Feb. 9, 2011, the contents of which are herein incorporated by reference.

### BACKGROUND OF THE INVENTION

The present invention relates to mounting brackets and, more particularly, to a bracket that allows CB-satellite radio antennas to be mounted on large commercial vehicles.

Certain large commercial vehicles do not have the capability to mount antennas, such as CB or satellite radio antennas. The location and design of certain mounting hardware may not be capable of mounting bot a CB and a satellite radio antenna. Moreover, antenna design and location for conventional mounts may allow constant signal interference and may be difficult to install.

As can be seen, there is a need for an improved antenna mounting bracket that may be easy to install and permit installation of multiple antennas on a single bracket.

### SUMMARY OF THE INVENTION

In one aspect of the present invention, an antenna mount comprises at least one angled bracket having a first side and a second side; at least one rod attached to and extending from the first side; at least one hole cut through the second side; and at least one antenna adapted to be mounted on the at least one rod.

In another aspect of the present invention, an antenna mount comprises an L-shaped bracket having a first side and a second side; first and second slots cut through the first side of the bracket; and first and second rods attached to and extending from the second side of the bracket, wherein the slots are adapted to align with a spot mirror mounting location on a vehicle.

In a further aspect of the present invention, a method for attaching at least one antenna to a vehicle comprises removing a spot mirror and spot mirror bolts from a door frame of the vehicle; aligning slots of an L-bracket with a spot mirror mount location, the L-bracket having a first side with the slots, and a second side extending generally perpendicular therefrom; reattaching the spot mirror by passing the spot mirror bolts through a spot mirror bracket of the spot mirror and through the slots of the L-bracket; and attaching one or more antennas to one or more rods attached to and extending from the second side of the L-bracket.

These and other features, aspects and advantages of the present invention will become better understood with reference to the following drawings, description and claims.

### BRIEF DESCRIPTION OF THE DRAWINGS

FIG. 1 is a perspective view of an antenna mount attached to a door spot mirror according to an exemplary embodiment of the present invention;

FIG. 2 is a perspective view of the antenna mount of FIG. 1;

FIG. 3 is a top perspective view of the bracket and rods of the antenna mount of FIG. 1;

FIG. 4 is a bottom perspective view of the bracket and rods of the antenna mount of FIG. 1;

FIG. 5 is a cross-sectional view taken along line 4-4 of FIG. 1;

FIG. 6 is an exploded view of an antenna and bracket of the antenna mount of FIG. 1; and

FIG. 7 is an exploded view of another antenna and bracket o the antenna mount of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an antenna mount for attaching an antenna to a commercial vehicle. Often, such vehicles do not include antenna mounts for items such as a CB or satellite radio. The antenna mount may permit such antennas to be installed, interconnecting with an existing spot mirror attachment point. The antenna mount includes a bracket adapted to connect to a vehicle, typically between a spot mirror and a vehicle door, using the existing spot mirror mounting bolts. One or more rods may extend from the bracket. Antennas may then be attached to the rods. The antenna mount may allow for mounting capability for CB and/or satellite radio antennas. The chosen location of the antenna mount, behind the spot mirror, may also maximize satellite and CB radio signals. For example, the CB radio signal may be within 1.1 to 1.5 SWR rating.

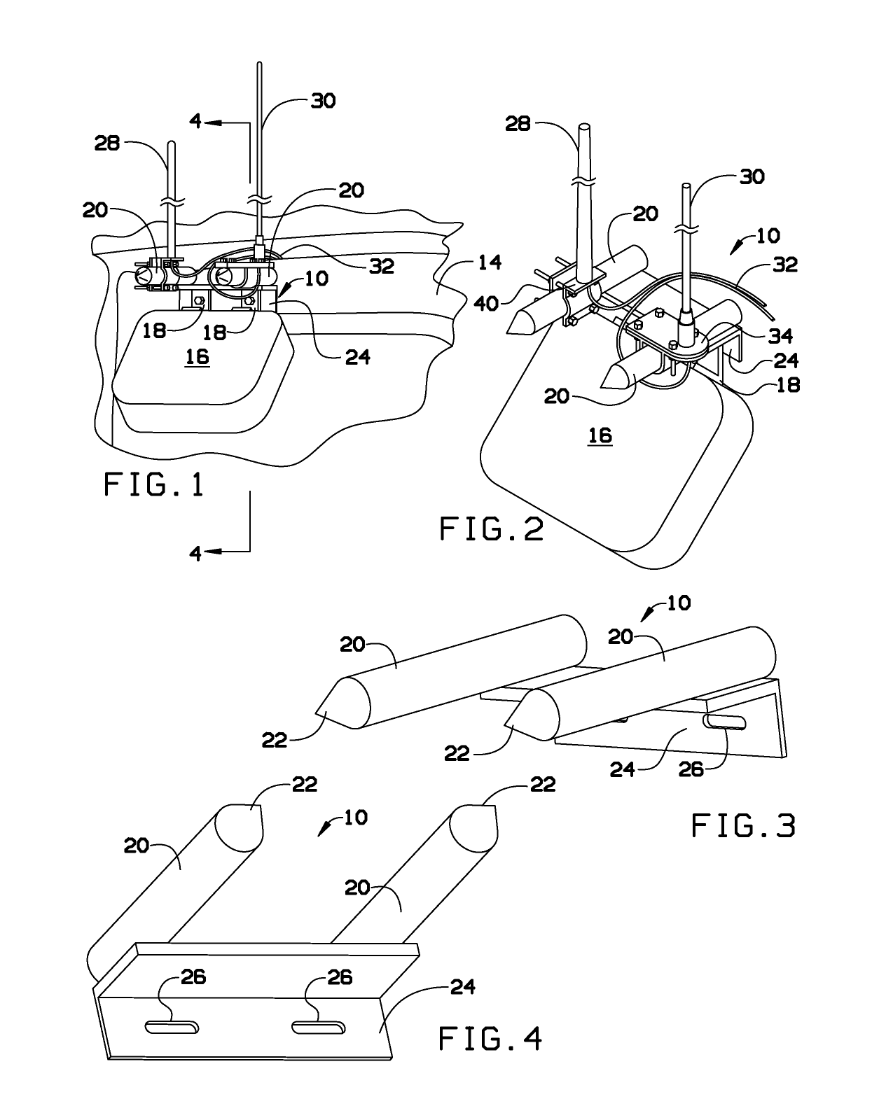

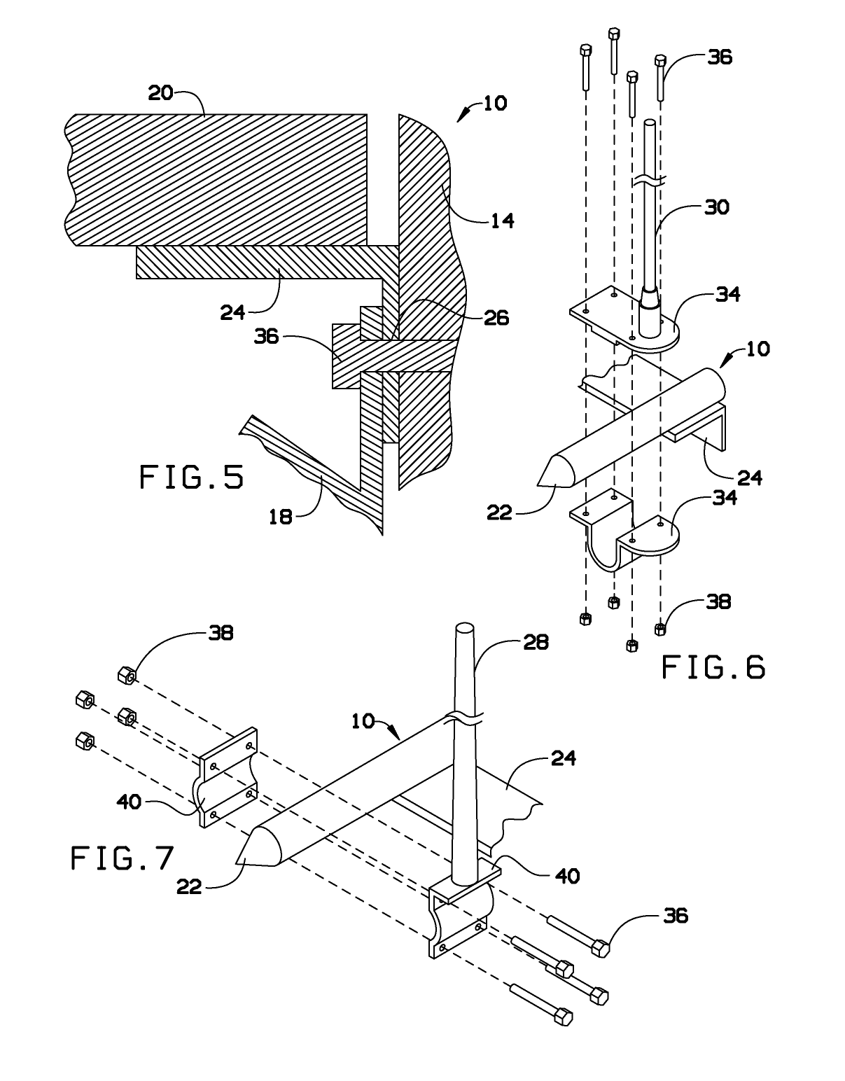

Referring now to FIGS. 1 through 7, an antenna mount 10 may include one or more angled brackets 24 having a slot 26 on a first side and a rod 20 extending from a second side of the bracket 24. In some embodiments, the bracket may be angled at about 90 degrees. A spot mirror 16 may be held onto a passenger side door frame 14 of a vehicle 12 with bolts 36 via spot mirror brackets 18. The angled bracket 24 may attach to the door frame 14 with the bolts 36 along with the spot mirror 16. In some embodiments, two angled brackets 24 may attach to each of two bolts 36 that secure the spot mirror 16, In other embodiments, as shown in FIGS. 1 and 2, an elongated L-bracket may have two slots 26 to align with the bolts 36 of the spot mirror 16. The bracket 24 may be positioned between the head of the bolt 36 and the spot mirror bracket 18 (which is adjacent to the door frame 14), or may be positioned between the spot mirror brackets 18 and the door frame 14, as shown in FIG. 5.

The L-bracket 24 may be about 5-7 inches long, typically about 6 inches long and may be made of a strong material, such as aluminum. The slot side of the bracket 24 may be about 1.5 inches wide, and the rod side of the bracket 24 may be about 2 inches long, although other lengths may be within the scope of the present invention. The bracket 24 may be about ¼ inch thick and the slot side of the bracket 24 may be made thinner, such as about ⅛ inch thick, so as not to disturb the original spot mirror mounting. The slots 26 may be about ⅜ inch high and about 1⅛ inch wide. The slots 26 may be apart a sufficient distance to align with the bolts 36 used for mounting the spot mirror 16, for example, about 2 inches apart.

The rods 20 may be attached to the rod attachment side of the bracket 24 by, for example welding. The rods 20, may be, for example, about 1 inch wide and about 5 to 6 inches long. The rods 20 may include a taper 22 on their ends for ease of antenna installation. The rods may be made in various lengths and may be made from any conductive or non-conductive material, such as aluminum.

One of the rods 20 may have a satellite antenna clamp bracket 40 attachable thereto, while the other one of the rods 20 may have a CB antenna clamp bracket 34 attachable thereto. The brackets 40, 34 may be two piece designs, as shown in FIGS. 6 and 7, attached with screws 36 and nuts 38. A CB antenna 30 may extend from the CD antenna clamp bracket 34 and a satellite antenna 28 may extend from the satellite antenna clamp bracket 40. A wire 32 may run from each antenna 30, 28 to the appropriate equipment (such as a CB or a satellite radio).

While the bracket described above has focused on satellite radio and CB antennas, other antennas may be used with the bracket. For example, cellular phone antennas, computer antennas, satellite TV antennas, or the like may be mounted on the bracket of the present invention.

It should be understood, of course, that the foregoing relates to exemplary embodiments of the invention and that modifications may be made without departing from the spirit and scope of the invention as set forth in the following claims.

What is claimed is:

1. An antenna mount comprising:
at least one angled bracket having a first side and a second side;
at least one rod attached to and extending from the first side;
at least one hole cut through the second side; and
at least one antenna adapted to be mounted on the at least one rod.

2. The antenna mount of claim 1, wherein the bracket is an L-bracket.

3. The antenna mount of claim 2, wherein the L-bracket includes two holes cut through the second side thereof, the two holes adapted to align with a spot mirror mounting location on a vehicle.

4. The antenna mount of claim 3, wherein the holes are slots.

5. The antenna mount of claim 3, further comprising two rods attached to the L-bracket.

6. The antenna mount of claim 1, wherein the at least one rod has a tapered end.

7. An antenna mount comprising:
an L-shaped bracket having a first side and a second side;
first and second slots cut through the first side of the bracket; and
first and second rods attached to and extending from the second side of the bracket, wherein
the slots are adapted to align with a spot mirror mounting location on a vehicle.

8. The antenna mount of claim 7, further comprising a first antenna adapted to be mounted to the first rod and a second antenna adapted to be mounted to the second rod.

9. A method for attaching at least one antenna to a vehicle, the method comprising:
removing a spot mirror and spot mirror bolts from a door frame of the vehicle;
aligning slots of an L-bracket with a spot mirror mount location, the L-bracket having a first side with the slots, and a second side extending generally perpendicular therefrom;
reattaching the spot mirror by passing the spot mirror bolts through a spot mirror bracket of the spot mirror and through the slots of the L-bracket; and
attaching one or more antennas to one or more rods attached to and extending from the second side of the L-bracket.

10. The method of claim 9, wherein the at least one antenna includes a CB antenna and a satellite radio antenna.
